(19) United States
(12) Patent Application Publication
(10) Pub. No.: US 2012/0138084 A1
(43) Pub. Date: Jun. 7, 2012

(54) Cleaning device using UV-ozone and cleaning method using the device

(76) Inventors: Kyul Han, Yongin-city (KR); Mu Hyun Kim, Yongin-city (KR); Sang Yeol Kim, Yongin-city (KR); Il Seok Park, Yongin-city (KR); Hyun Sung Kang, Yongin-city (KR)

(21) Appl. No.: 13/135,758

(22) Filed: Jul. 13, 2011

(30) Foreign Application Priority Data
Dec. 2, 2010 (KR) 10-2010-0122008

(51) Int. Cl. B08B 7/04; B08B 5/00

(52) U.S. Cl. 134/1; 134/56 R

(57) ABSTRACT

A contaminant cleaning device includes a stage configured to house a substrate; an imaging means configured to obtain an image of a contaminant on the substrate; a control means configured to recognize the image and configured to generate a control signal in accordance with the recognized image; a UV generating means; an irradiation shape forming unit configured to selectively block a passage of UV radiated from the UV generating means to make a UV irradiated shape correspond to a shape of the image recognized in the control means; and an interrupter configured to receive a control signal from the control means to block or allow passage of UV from the UV generating means, wherein the stage is configured to move in accordance with a control signal from the control means to enable a contaminant on the substrate to be positioned in the area to which UV is irradiated.

### CROSS-REFERENCE TO RELATED APPLICATION

This application claims the benefit of Korean Patent Application No. 10-2010-0122008, filed on Dec. 2, 2010 with the Korean Intellectual Property Office, which is hereby incorporated by reference in its entirety.

### TECHNICAL FIELD

The present invention relates to a device for cleaning a substrate and a cleaning method thereof.

### BACKGROUND ART

In general, a process for manufacturing a semiconductor, a display or the like includes a process of cleaning a substrate.

Examples of the process for cleaning a substrate include a process using a radical ion generated by irradiating UV to oxygen (O₂) and ozone (O₃) (hereinafter, referred to as a “UV-ozone treatment process”), a process using a chemical solution comprising ozone water, HF, and others (hereinafter, referred to as a “chemical solution cleaning process”), a process of physically dropping deionized (DI) water in a DI water sonification/shower (hereinafter, referred to as a “physically dropping process”), a high pressure jet shower process. In addition to these processes, a process of injecting low-pressure gas into a vacuum chamber and generating plasma is used to clean a substrate.

However, among the foregoing processes, the chemical solution cleaning process and the physically dropping process have problems in that chemicals such as a solvent may penetrate into a circuit already formed on a substrate thereby damaging the circuit. For effective cleaning, the intensity of solvent treatment needs to be maximized, which may also result in damage to the substrate and the circuit. Accordingly, the intensity of the solvent treatment and the protection of the substrate circuit characteristics are in conflict.

In case of the UV-ozone treatment process and the plasma treatment process using a radical ion, a radical reaction usually occurs in a contaminant site exposed on a substrate, but may occur on a substrate site where no contaminant exists, thereby damaging the substrate. For example, in case of local contamination caused by local adsorption of a contaminant, if UV-ozone or plasma is treated on an entire surface of a substrate, the contaminant can be removed. However, other sites, that is, clean sites of the substrate, may also be exposed to the UV light (“UV”) or the plasma so that they are damaged. As a result, chemical characteristics of the clean substrate sites, onto which no contaminant has been adsorbed, may be changed. Accordingly, there is a difficulty in applying the conventional processes to removing a local contaminant.

Additionally, in case of processing a large base substrate glass that is to be cut into a plurality of small individual display substrates, it is possible to discard each individual display substrate having a defect and to select other individual display substrates having no defect. However, in a large display, in which an entire base substrate glass becomes one display substrate, one defect means a defect of the whole display substrate. Thus, removing a local residual contaminant on the large display substrate is highly important. Accordingly, cleaning is very important.

### SUMMARY

Embodiments of the present invention provide a cleaning device in which UV is selectively irradiated only to a contaminant site thereby selectively removing only the contaminant. More specifically, embodiments of the present invention provide a cleaning device, in which an imaging means such as a camera monitors a shape of a contaminant on a substrate in real time, and a UV irradiation area is adjusted to correspond to the shape of the contaminant, thereby selectively removing only the contaminant.

In one embodiment, a cleaning device is provided which removes a contaminant while monitoring a position, size, shape of a contaminant existing on a substrate by using an imaging means such as a camera, and adjusting UV irradiation shape toward the substrate to make the UV irradiation surface on the substrate correspond to the contaminant area thereby enabling UV to be irradiated only to the contaminant site. As used herein, “UV irradiation shape” means a cross-sectional shape of UV beam irradiating toward the substrate or generally a shape of the UV irradiation area on the substrate.

According to one exemplary embodiment of the present invention, the imaging means monitors, films or photographs variations of a position, a size and a shape of the contaminant in real time. By reflecting the variations, a position, a size and a shape of the UV irradiation are adjusted.

The contaminant cleaning device according to the present invention is applied to any type of contaminant without specific limitation. As the examples of the contaminant, there are various types of contaminants including organic substance, inorganic substance, and a metal component. In case of cleaning a display device, for example, the contaminant would be mostly organic substance.

The contaminant cleaning device according to one exemplary embodiment of the present invention comprises: a stage 100, on which a substrate 200 is positioned; an imaging means 900 for obtaining an image of a contaminant existing on a surface of the substrate 200; a control means 1000 for recognizing the image obtained by the imaging means 900 and generating a control signal in accordance with the recognized image; a UV generating means 800; an irradiation shape forming unit 700, which selectively blocks a passage of UV radiated from the UV generating means to make a UV irradiation shape toward the substrate correspond to the image recognized in the control means; and an interrupter 400, which is open and closed in accordance with a control signal of the control means 1000 to block or pass UV.

The stage 100 moves in accordance with a control signal of the control means 1000 to enable the UV to be irradiated to a contaminant existing on the substrate 200. Specifically, the stage 100 is equipped with a movement means 110, whereby the stage, on which a substrate is positioned, can move in accordance with a control signal of the control means to enable a contaminant on the substrate to be positioned in an area, to which the UV is irradiated.

According to one exemplary embodiment of the present invention, the contaminant cleaning device may include a chamber 500, and the stage 100, on which a substrate is positioned, can be positioned in the chamber 500.

According to one exemplary embodiment of the present invention, the chamber 500 may further include a gas supplying means for supplying at least one of oxygen and ozone into the chamber.

According to one exemplary embodiment of the present invention, the contaminant cleaning device may further include a lens means 300 for condensing UV that has passed through the irradiation shape forming unit 700. By virtue of the lens means 300, it is possible to adjust the size of a UV irradiation area on the substrate.

According to one exemplary embodiment of the present invention, the contaminant cleaning device may further include a mirror for reflecting UV radiated from the UV generating means 800 to adjust an irradiation direction. According to one exemplary embodiment of the present invention, the mirror 600 may be positioned in front of the irradiation shape forming unit 700 or in the rear of the irradiation shape forming unit 700.

According to one exemplary embodiment of the present invention, the irradiation shape forming unit 700 can make a UV irradiation shape proportionally larger than the image recognized in the control means. That is, the irradiation shape forming unit 700 can make the cross-section of UV beam passing through the irradiation shape forming unit 700 proportionally larger than the size of the contaminant on the substrate. In such case, the size of the UV irradiation area on the substrate can be controlled by using the lens means 300, in which the lens means 300 can condense UV irradiation size to be identical or similar to a contaminant size.

According to one exemplary embodiment of the present invention, the irradiation shape forming unit 700 may include a plurality of blocking plates. Each of the plurality of blocking plates may have a movement unit enabling each of the plurality of blocking plates to independently move. By moving each of the plurality of blocking plates, it is possible to make UV passing through the irradiation shape forming unit have a cross-sectional shape corresponding to a contaminant shape.

According to one exemplary embodiment of the present invention, the irradiation shape forming unit 700 can enable a UV irradiation shape to vary in correspondence with variation of a shape of a contaminant according as removing the contaminant is progressed.

According to one exemplary embodiment of the present invention, the imaging means 900 can be selected from a group consisting of a CCD camera, a photoluminescence microscopy, and a photoelectron microscopy.

According to one exemplary embodiment of the present invention, in order to alleviate the UV intensity at a boundary portion of a UV irradiation area on the substrate 200, at least one of a diffuser plate, a raster scanner, and a vibrator can be disposed between the irradiation shape forming unit 700 and the substrate.

The contaminant cleaning device according to the present invention can be effectively applied to removing a local minute contaminant.

The present invention also provides a method of cleaning a residual contaminant on a substrate.

The contaminant cleaning method may include the following steps: (a) positioning a substrate 200 on a stage 100; (b) obtaining an image of a contaminant existing on a surface of the substrate by using an imaging means 900; (c) recognizing the image obtained by the imaging means and generating a control signal in accordance with the recognized image in the control means 1000; (d) generating UV; (e) controlling a UV irradiation shape toward the substrate to correspond to the image recognized in the control means, by selectively blocking a passage of the UV in accordance with the control signal; (f) progressing cleaning by irradiating the UV, for which the irradiation shape is controlled, to a contaminant site of the substrate, and supplying at least one of oxygen and ozone.

According to one exemplary embodiment of the present invention, the contaminant cleaning method may further include a step of moving the stage 100 in a state that irradiation of UV toward the substrate is blocked, to enable the contaminant site of the substrate to be positioned in the UV irradiation site, prior to or after the step (e).

According to one exemplary embodiment of the present invention, the step of controlling a UV irradiation shape is performed in a state that irradiation of UV toward the substrate is blocked.

According to one exemplary embodiment of the present invention, the cross section of the UV in the step (e) is controlled to have a shape corresponding to the shape of the image recognized in the control means, however the size of the cross section of UV in the step (e) is controlled to be larger than the size of the image recognized in the control means.

According to one exemplary embodiment of the present invention, in the UV irradiation shape controlling step, it is possible to enable the UV irradiation shape to vary in correspondence with variation of a shape of a contaminant according as cleaning is progressed.

According to one exemplary embodiment of the present invention, a size of the contaminant may be in a range of 1 to 1000 μm. The cleaning method according to the present invention can be effectively applied to cleaning a local minute contaminant.

According to one exemplary embodiment of the present invention, there is provided a method of cleaning a residual contaminant on a substrate including the following steps of: (a) positioning a substrate on a stage; (b) obtaining an image of a contaminant existing on a surface of the substrate by using an imaging means; (c) recognizing the image obtained by the imaging means and generating a control signal in accordance with the recognized image in the control means 1000; (d) generating UV; (e) controlling a UV irradiation shape toward the substrate to correspond to the image shape recognized in the control means, by selectively blocking a passage of the UV in accordance with the control signal; (f) progressing cleaning by irradiating the UV, for which the irradiation shape is controlled, to a contaminant site of the substrate, and supplying at least one of oxygen and ozone; (g) monitoring variation of a shape of the contaminant in real time as cleaning is progressed by using the imaging means to obtain a new image; (h) recognizing the new image and generating a new control signal in accordance with the newly recognized image in the control means; and (i) controlling the UV irradiation shape again in accordance with the new generated control signal to make the UV irradiation shape in correspondence with the image newly recognized in the control means.

The contaminant cleaning method according to the present invention can be applied together with a UV-ozone pretreatment using a linear or large dimension UV beam which is used in a conventional method for cleaning an entire dimension, or together with a large dimension plasma treatment method.

By using contaminant cleaning device according to embodiments of the present invention, it is possible to selectively remove a contaminant by selectively irradiating UV to a contaminant site. The cleaning method using the contaminant cleaning device according to embodiments of the present invention is useful especially for removing a local contaminant. For example, it can be effectively applied to removing a residual minute contaminant during manufacturing a display device. In that case, it is possible to selectively remove only a contaminant without causing a change in chemical characteristics of a substrate surface.

### BRIEF DESCRIPTION OF THE DRAWINGS

FIG. 1 is a schematic view showing configuration of a contaminant cleaning device according to one exemplary embodiment of the present invention.

FIG. 2 is a schematic view of positioning a UV generating means 800, an irradiation shape forming unit 700, and a mirror 600 according to one exemplary embodiment of the present invention.

FIG. 3 shows a basic state of an irradiation shape forming unit 700 according to one exemplary embodiment of the present invention.

FIG. 4 shows that a shape of an aperture 701 of the irradiation shape forming unit 700, through which UV passes, is varying according to the shape change of the contaminant. The shape of the aperture 701 is formed by the movement of the blocking plates each having a movement unit capable of independently moving.

FIG. 5a illustrates a linear UV beam, which has been applied to a conventional cleaning device.

FIG. 5b illustrates a UV beam irradiating a substrate after passing through a irradiation shape forming unit according to one exemplary embodiment of the present invention, wherein the UV beam is controlled to have an irradiation shape corresponding to a shape of a contaminant.

FIG. 6 shows a irradiation shape forming unit according to another exemplary embodiment of the present invention, wherein a plurality of blocking plates move in the form of an iris of a camera thereby adjusting an irradiation shape of UV passing through the irradiation shape forming unit.

FIG. 7 is a schematic view showing a contaminant cleaning device according to another exemplary embodiment of the present invention, wherein a space is divided by a window 510.

FIG. 8 is a schematic view showing a use of a capillary tube as a means to supply process gas including at least one of oxygen and ozone to a local area, in another exemplary embodiment of the present invention.

FIG. 9 is a schematic view showing one exemplary embodiment, wherein a diffuser plate 820 is additionally provided between the irradiation shape forming unit 700 and the mirror 600.

FIG. 10a illustrates the state of an ITO electrode and a PDL film, which are formed on a substrate, prior to UV-ozone cleaning using the cleaning device according to the present invention.

FIG. 10b illustrates the state of an ITO electrode and a PDL film, which are residual on the substrate of FIG. 10a, after UV-ozone cleaning using the cleaning device according to the present invention.

### DETAILED DESCRIPTION

Hereinafter, the contaminant cleaning device and the cleaning method thereof according to the present invention will be described in detail with respect to the drawings.

### Example 1

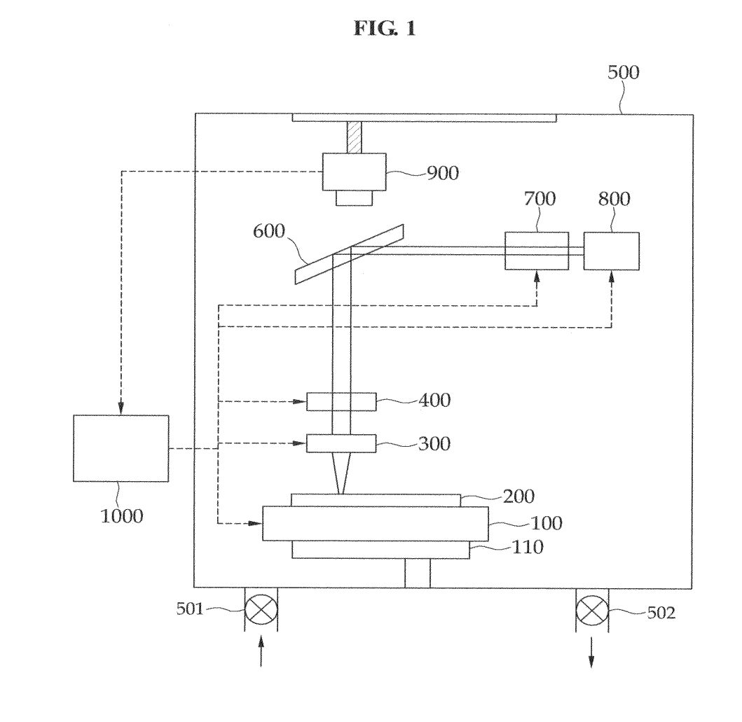

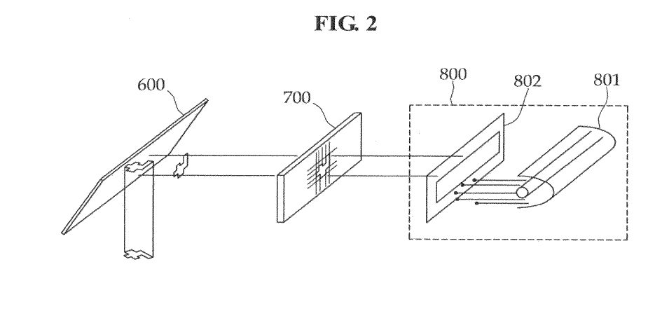

FIG. 1 is a schematic view showing configuration of a contaminant cleaning device according to the present example. FIG. 2 schematically illustrates positioning a UV generating means 800, an irradiation shape forming unit 700, and a mirror 600 in the present example.

The contaminant cleaning device according to the present example, as illustrated in FIG. 1, includes a stage 100, on which a substrate 200 is positioned, a moving means 110 for moving the substrate positioned on the stage 100 by moving the stage 100, an imaging means 900 for obtaining an image of a contaminant existing on the substrate surface, a UV generating means 800, a irradiation shape forming unit 700 for adjusting a UV irradiation shape onto the substrate to correspond to a shape of the image obtained by the imaging means, a mirror 600 for adjusting a irradiation direction of UV, an interrupter 400 for blocking or passing UV, a lens means 300 for condensing UV, and a control means 1000 for controlling each of the components.

For reference, if the UV generating means 800 and the irradiation shape forming unit 700 are aligned with the substrate, the mirror 600 may not be required. If a size of irradiation dimension of UV passing through the irradiation shape forming unit is identical or similar to a size of a contaminant, the lens means 300 may not be required.

In the present example, the above components except the control means 1000 are contained in one chamber 500.

The substrate 200 to be cleaned is mounted on the stage 100.

Types of the substrate are not limited, and various substrates such as a substrate for manufacturing a display and a substrate for a semiconductor may be applied. Hereinafter, the examples will be described based on a substrate for a display.

The stage 100 includes a movement means 110. The movement means 110 moves the stage 100 thereby moving the substrate. In this case, the movement of the movement means 110 is controlled by the control means 1000. The control means 1000 recognizes a position of a contaminant on the substrate, and controls the movement thereof to enable a site of a contaminant existing on the substrate to be positioned in an area to which UV is irradiated. That is, the control means controls the movement means to move such that a contaminant site of the substrate disposed on the stage is positioned in the UV irradiation area.

In order to enable UV to be irradiated toward a site of a contaminant existing on the substrate, it is also possible to move the mirror 600, the lens means 300 and the interrupter 400 together toward the contaminant site. However, in the present example, only the stage and the substrate are moved by the movement means 110.

The imaging means 900 generates image information about the contaminant on the surface of the substrate. The imaging means monitors and obtains the image of the contaminant by filming or photographing the contaminant. Examples of the imaging means 900 include a charge-coupled device (CCD) camera, a photoluminescence microscope, a photoelectron microscopy, and others. The present example uses a CCD camera as the imaging means.

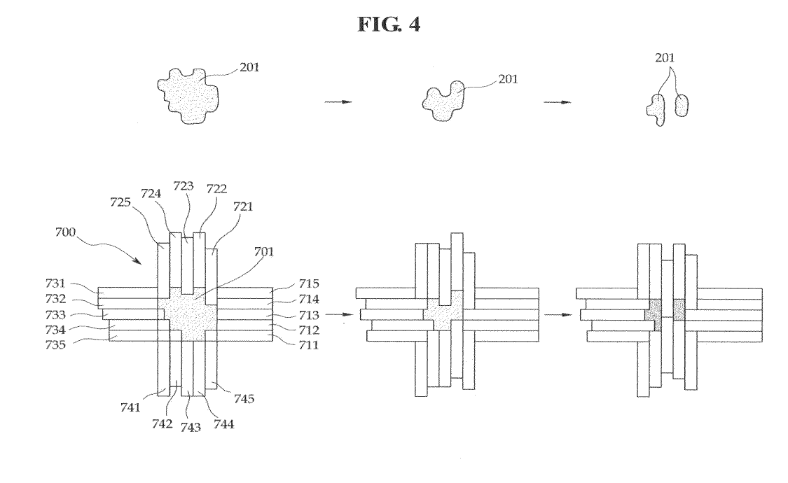

The imaging means can film or photograph variation of a shape of a contaminant which is gradually removed as cleaning is progressed in real time during the cleaning process. FIG. 4 shows variation of a shape of the contaminant 201 as cleaning is progressed. The imaging means films or photographs variation of a shape of the contaminant to transmit the information thereof to the control means.

The control means 1000 receives the image information about a position, size and shape of the contaminant obtained by the imaging means to recognize the contaminant 201. Based on the recognition, the control means 1000 generates control signals to control the movement means 110, the UV generating means 800, the irradiation shape forming unit 700, the interrupter 400 and the lens means 300.

The UV generating means 800 generates and radiates UV. The UV generating means may continuously generate UV during the operation of the contaminant cleaning device, or only when UV generation is required upon receiving a signal from the control means.

FIG. 2 shows one example of a UV generating means 800. The UV generating means 800 illustrated in FIG. 2 includes a UV light source 801 and a blocking plate 802.

The irradiation shape forming unit 700 is located in front of the UV generating means 800 in the UV propagation direction.

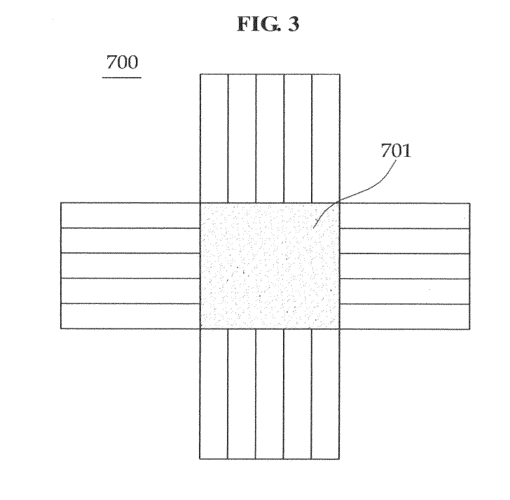

The irradiation shape forming unit 700 selectively blocks a passage of UV radiated from the UV generating means thereby making the shape of UV irradiating onto the substrate generally correspond to the image of the contaminant recognized by the control means. FIGS. 3 and 4 illustrate one example of the irradiation shape forming unit.

The irradiation shape forming unit illustrated in FIGS. 3 and 4 has a structure in which 5 blocking plates are formed in each of 4 directions such that a total of 20 blocking plates, 711, 712, 713, 714, 715, 721, 722, 723, 724, 725, 731, 732, 733, 734, 735, 741, 742, 743, 744 and 745, are formed. Since each of the blocking plates has a movement unit capable of enabling each of the blocking plates to independently move, each of the blocking plates can perform backward and forward movement in one axis direction.

FIG. 3 shows a basic state of the irradiation shape forming unit 700, wherein the aperture 701 formed by the blocking plates is open to the maximum.

Based on the contaminant image obtained by the imaging means 900, the control means 1000 controls the movement of the movement unit provided in each of the blocking plates to form the aperture 701 corresponding to the contaminant image.

FIG. 4 shows the shape of the aperture 701 of the irradiation shape forming unit 700, which is formed by the movement of blocking plates with control signals from the control means. FIG. 4 also shows variations of the shape of the aperture 701. At the irradiation shape forming unit 700, UV passes through the aperture 701 but UV at the other sites is blocked by the blocking plates such that the cross section of the UV passing through the irradiation shape forming unit 700 becomes substantially identical to the aperture 701 of the irradiation shape forming unit.

Even though it is difficult for the shape of the aperture to become exactly identical to the shape of the contaminant, the shape of the aperture 701 can be controlled to be as similar as possible to the shape of the contaminant, and thus the shape of UV passing through the irradiation shape forming unit can be controlled to be similar to the shape of the contaminant. In FIG. 4, the upper portion shows the shape of the contaminant 201, and the lower portion shows the aperture 701 of the irradiation shape forming unit 700, which is formed to be similar to the shape of the contaminant.

It is possible to block irradiation of the UV toward the substrate when the irradiation shape forming unit 700 operates to form a shape of aperture. In other words, the interrupter 400 is closed to block irradiation of UV toward the substrate such that UV is blocked to not reach the substrate during adjustment of the blocking plates to form UV irradiation shape thereby preventing unnecessary damage to the substrate.

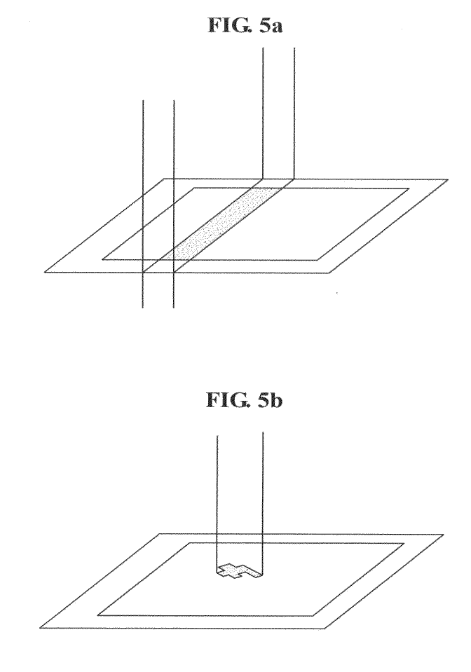

FIG. 5a illustrates that a linear UV beam is irradiated to a substrate in a conventional cleaning device. FIG. 5b illustrates that UV is irradiated to a substrate after passing through the irradiation shape forming unit according to an example of the present invention.

If the conventional technology illustrated in FIG. 5a is applied, UV is irradiated to a site where no contaminant exists as well as a site where contaminant exists on a substrate. As a result, a radical reaction of ozone/oxygen may occur on a surface of the substrate where no contaminant exists, thereby damaging the substrate surface. On the other hand, if an embodiment of the present invention is applied, UV is irradiated only to a contaminant site as illustrated in FIG. 5b so that unnecessary damage to the substrate can be minimized.

With respect to embodiments of the present invention, the imaging mans 900 films or photographs variation of the shape of the contaminant 201 in real time as cleaning is progressed and transmits the information to the control means. In correspondence with the variation of the contaminant shape, the control means controls the irradiation shape forming unit 700. As a result, as illustrated in FIG. 4, the movement of the blocking plates are controlled in correspondence with the variation of the shape of the contaminant 201 according as cleaning is progressed, so that the shape of UV passing through the aperture 701 of the irradiation shape forming unit 700 can also vary in correspondence with the variation of the shape of the contaminant.

In the present example, a mirror 600 is located in front of the irradiation shape forming unit 700.

The mirror adjusts an irradiation direction of UV and is a selective component. If the UV generating means 800 and the irradiation shape forming unit 700 are aligned with the substrate 200, the mirror may not be required. In the present example, the mirror is provided to facilitate adjustment of a UV irradiation direction. A mirror capable of reflecting light and enabling photographing, for example, a dichroic mirror is used in the present example.

In the present example, the mirror is fixed after it is installed. If necessary, the mirror may be installed in the manner such that a position thereof can be adjusted.

UV reflected on the mirror passes through the interrupter 400. The present example uses a chopper type of an interrupter, which is open or closed in accordance with a control signal of the control means to block or pass UV reaching the lens means 300.

The interrupter 400 prevents UV from unnecessarily reaching the substrate. The interrupter is provided to enable UV to be irradiated toward the substrate only when a contaminant site on the substrate 200 is positioned in a UV irradiation area. That is, when the control means 1000 recognizes a position of a contaminant existing on the substrate, the control means controls the movement of the movement means 110 to move the stage 100 thereby moving the substrate 200 so that the site of the contaminant existing on the substrate is positioned in a UV irradiation site. While the movement means moves the stage, the interrupter 400 is closed. When the control means recognizes that the site of the contaminant on the substrate is positioned in the UV irradiation site, the control means transmits a predetermined command, and then the interrupter receives the command and becomes open. When the interrupter is open, UV is irradiated toward the substrate.

The lens means 300 is located under the interrupter 400. The lens means 300 is configured to condense UV passing through the interrupter. The present example uses a convex lens as the lens means.

According to another embodiment of the present invention, the lens means 300 may be replaced with a lens array consisting of a plurality of lens to facilitate UV condensing.

If UV condensing is not required, the lens 300 may not be required. For example, if a size of a cross section of UV passing through the irradiation shape forming unit is identical or similar to a size of a contaminant, UV condensing using the lens means would be unnecessary.

In the present example, cross sectional area of UV passing through the irradiation shape forming unit 700 is configured to be proportionally larger than the image of the contaminant recognized in the control means. In general, a contaminant partially exists on a substrate and has a very small dimension. In the present example, a cross sectional shape of UV passing through the irradiation shape forming unit is controlled by adjusting a plurality of blocking plates located in the irradiation shape forming unit. However, it is difficult to form a size and a shape of the aperture 701 identical to a contaminant having a very small dimension. Accordingly, in the present example, the irradiation shape forming unit is controlled to form an aperture shape proportionally larger than the size of the contaminant recognized in the control means. After passing the irradiation shape forming unit, UV is condensed by the lens means, so that the size of the irradiated UV can be properly reduced when it reaches the substrate, while maintaining its shape.

The contaminant cleansing device of the present example can further comprise a lens adjusting means for upwardly and downwardly moving the lens means 300 with respect to the substrate 200. A degree of UV condensing and a size of the area to which UV is irradiated can be controlled by upwardly and downwardly adjusting the position of the lens means. UV condensed by passing through the lens means as described above is irradiated to a contaminant site of the substrate.

The position of the lens means 300 and the position of the interrupter 400 may be interchanged with each other.

The chamber 500 may include a means for supplying process gas into the chamber. The present example includes a gas inlet 501 and a gas outlet 502 as illustrated in FIG. 1. Process gas applied to the present example is at least one of oxygen and ozone. A mixture of oxygen and ozone may be used.

When the process gas is injected into the gas inlet 501, and UV is irradiated to the site of the contaminant 201 on the substrate, ozone or oxygen is radicalized. The radical reacts with the contaminant thereby removing the contaminant.

The above cleansing operation repeats until no contaminant having a diameter 1 μm or more on the surface of the substrate 200 is detected by the imaging means 900 in real time.

### Example 2

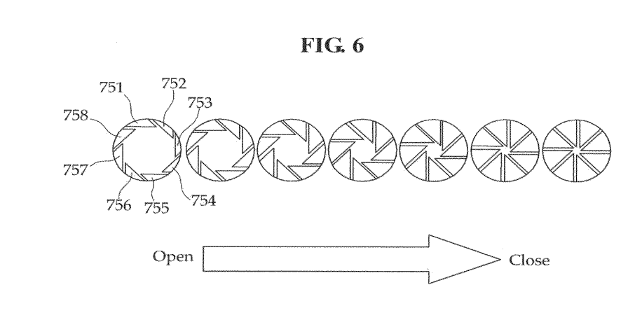

As another example of the present invention, there is a contaminant cleaning device having a irradiation shape forming unit as illustrated in FIG. 6.

The contaminant cleaning device according to the present example has an irradiation shape forming unit for adjusting a UV irradiation shape, in which a plurality of blocking plates, 751, 752, 753, 754, 756, 757 and 758, moves in a form of an iris of a camera. The contaminant cleaning device according to the present example may be same with the contaminant cleaning device illustrated in FIG. 1 except that the irradiation shape forming unit is that of FIG. 6.

### Example 3

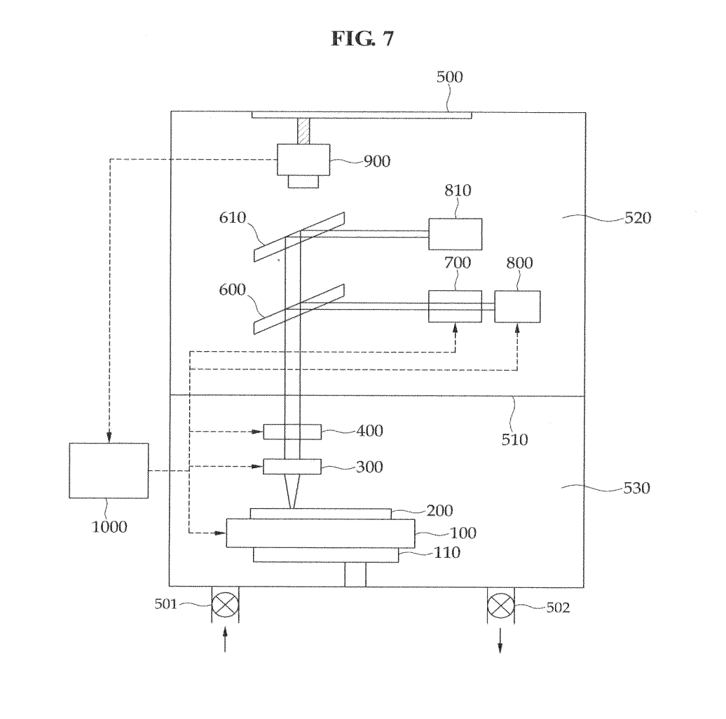

FIG. 7 shows another example of the present invention.

In the example according to FIG. 7, the chamber 500 space is divided by the window 510. The chamber space is divided into an upper chamber 520 and a lower reaction chamber 530. In the present example, the upper chamber can be an inert atmosphere filled with an inert gas such as nitrogen (N₂) so that the stability of components contained in the chamber 520 can be improved.

The present example further includes an additional lighting means 810 and a lighting mirror 610 for reflecting light radiated from the lighting means toward the substrate.

In the present example, the components contained in the chamber are an imaging means 900, a lighting means 810, a lighting mirror 610, a UV generating means 800, a irradiation shape forming unit 700, and a mirror 600.

### Example 4

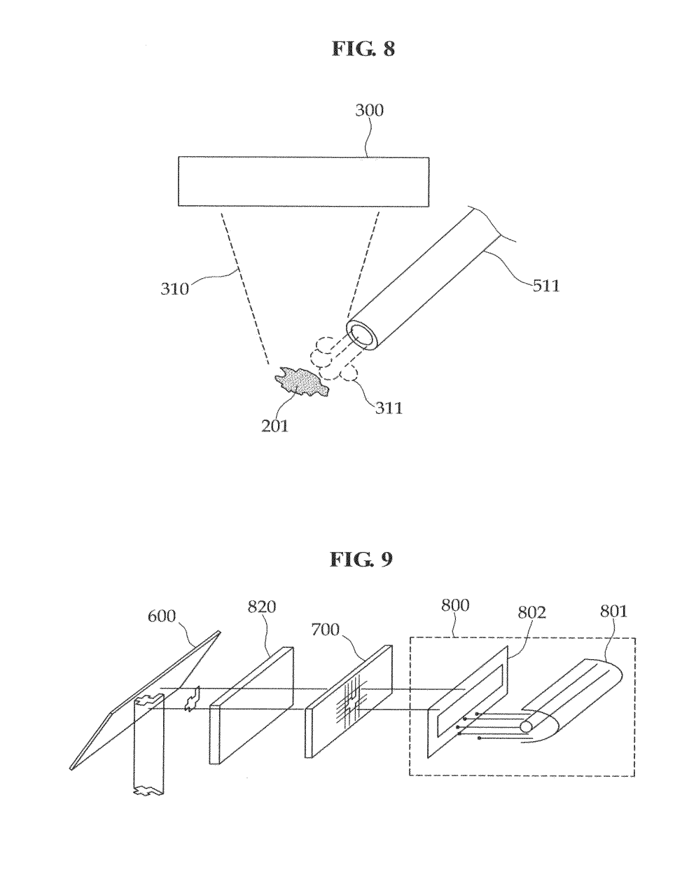

As another example of the present invention, there is a contaminant cleaning device having a process gas injecting means 511 illustrated in FIG. 8.

In the example according to FIG. 8, process gas 311 including oxygen and ozone is locally supplied by using the process gas injecting means 511 in the form of a capillary tube. That is, local cleaning is possible by injecting the process gas 311 at the site of contaminant by using the process gas injecting means 511 in the state that UV 310 is adjusted to be irradiated only to the site of the contaminant 201 of the substrate.

In the present example, the reaction chamber 530 described in Example 3 is removed, and process gas is supplied by using the process gas injecting means in the form of a capillary tube so that unnecessary diffusion of a radical reaction of ozone/oxygen can be prevented with increasing gas use efficiency.

### Example 5

FIG. 9 shows an example wherein a diffuser plate 820 is additionally provided in the contaminant cleaning device.

The diffuser plate 820 is configured to alleviate the UV intensity in at a boundary of the UV irradiation site. Instead of the diffuser plate, any one of a raster scanner and a vibrator may be used.

According to and embodiment of the present invention, a shape of a UV irradiation area on a substrate is adjusted by using the irradiation shape forming unit (700). Even though the UV irradiation area is adjusted by the irradiation shape forming unit, the UV irradiation area on the substrate cannot be exactly identical to a shape of a contaminant. Accordingly, even though the irradiation shape is controlled, when UV is irradiated to the substrate, a boundary or edge portion of the UV may reach a clean site of the substrate where no contaminant exists. In such case, the clean site of the substrate, which is irradiated by UV, may be somewhat damaged. Accordingly, the present example intends to reduce the UV intensity at a boundary or edge portion of UV irradiation area by using the diffuser plate 820 thereby minimizing damages to the substrate.

### Experimental Example

During a manufacture of a display, for example an OLED, a pixel define layer (PDL) residue may remain in a pixel unit after exposure and a developing process of a PDL. The PDL residue is sometimes strongly adsorbed onto a surface of ITO electrode, and the PDL residue is not easily removed by a conventional cleaning method thereby causing defects in a display panel. Such residue may be removed by UV-ozone treatment or plasma treatment. However, there are problems that sizes of residues are different, and the UV-ozone treatment and the plasma treatment can cause damages in chemical characteristics of a substrate site where no residue exists.

Accordingly, in the present experimental example, a test was conducted as described below to identify the degree of damages to a substrate site other than a contaminant site in case of using the contaminant cleaning device according to the present invention.

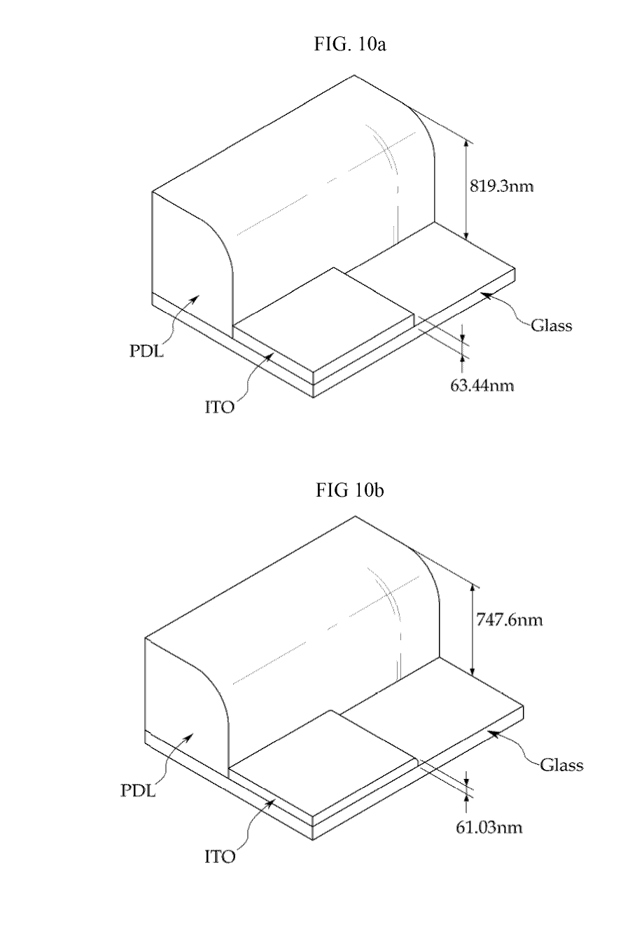

A glass was used as a substrate, and the glass substrate was selectively patterned by an ITO electrode. Subsequently, a PDL pattern was formed on the ITO electrode sites and other sites of the glass substrate. Then, cleaning was performed by using the contaminant cleaning device according to the present invention. In this test, a contaminant is the PDL pattern, and it was measured how much other sites of the substrate, i.e., the ITO electrode sites were damaged during removing the PDL pattern. FIGS. 10a and 10b illustrate the results. FIG. 10a shows the state prior to the UV-ozone cleaning. FIG. 10b shows the state after the cleaning.

According to the experimental example, while PDL was removed by approximately 70 nm, that is, from 819.3 nm to 747.6 nm, after the cleaning using UV-ozone, the damage to the ITO electrode was approximately 2 nm, that is, from 63.44 nm to 61.03 nm, which is minute and insignificant.

According to the results, if the contaminant cleaning device according to the present invention is used, a contaminant can be selectively removed without a serious damage at the other sites.

Description of Reference Numerals

| | |
|---|---|
| 100: stage | 110: movement means |
| 200: substrate | 300: lens means |
| 400: interrupter | 500: chamber |
| 501: inlet | 502: outlet |
| 510: window | 520: chamber |
| 530: reaction chamber | 600, 610: mirror |
| 700: irradiation shape forming unit | 800: UV generating means |
| 801: UV light source | 802: blocking plate |
| 810: lighting | 820: diffuser plate |
| 900: imaging means | 1000: control means |

1. A contaminant cleaning device comprising:
a stage configured to house a substrate;
an imaging means configured to obtain an image of a contaminant on the substrate;
a control means configured to recognize the image obtained by the imaging means and configured to generate a control signal in accordance with the recognized image;
a UV generating means;
an irradiation shape forming unit configured to selectively block a passage of UV radiated from the UV generating means to make a UV irradiated shape generally correspond to a shape of the image recognized in the control means; and
an interrupter configured to receive a control signal from the control means to control passage of UV from the UV generating means,
wherein the stage is configured to move in accordance with a control signal from the control means to enable a contaminant on the substrate to be positioned in the area to which UV is irradiated.

2. The contaminant cleaning device according to claim 1, further comprising a chamber housing the stage.

3. The contaminant cleaning device according to claim 2, wherein the chamber comprises a gas supplying means configured to supply at least one of oxygen and ozone into the chamber.

4. The contaminant cleaning device according to claim 1, further comprising a lens means configured to condense UV that has passed through the irradiation shape forming unit.

5. The contaminant cleaning device according to claim 1, further comprising a mirror configured to reflect UV radiated from the UV generating means to adjust a irradiation direction.

6. The contaminant cleaning device according to claim 5, wherein the mirror is generally aligned with the irradiation shape forming unit.

7. The contaminant cleaning device according to claim 1, wherein the irradiation shape forming unit is configured to generate a UV irradiation shape proportionally larger than the image recognized by the control means.

8. The contaminant cleaning device according to claim 1, wherein the irradiation shape forming unit comprises a plurality of blocking plates, wherein each of the blocking plates is configured to move independently.

9. The contaminant cleaning device according to claim 1, wherein the irradiation shape forming unit is configured to enable a UV irradiation shape to vary as a shape of a contaminant varies during removing of the contaminant.

10. The contaminant cleaning device according to claim 1, wherein the imaging means is selected from a group consisting of a CCD camera, a photoluminescence microscope, and a photoelectron microscope.

11. The contaminant cleaning device according to claim 1, further comprising any one of a diffuser plate, a raster scanner, and a vibrator, which is located between the irradiation shape forming unit and the substrate and is configured to alleviate a UV intensity at a boundary portion of the UV irradiation area on the substrate.

12. The contaminant cleaning device according to claim 1, wherein the device is configured to operate on a contaminant having a size of between about 1 μm to about 1000 μm.

13. A method for cleaning a residual contaminant on a substrate by using UV, the method comprising:
positioning a substrate on a stage;
obtaining an image of a contaminant on a surface of the substrate by using an imaging means;
recognizing the image obtained by the imaging means and generating a control signal in accordance with the recognized image by a control means;
generating UV;
controlling a UV irradiation shape toward the substrate to correspond to a shape of the image recognized in the control means by selectively blocking a passage of the UV in accordance with the control signal; and
cleaning the contaminant by irradiating the UV, for which the irradiation shape is controlled, to the contaminant, and supplying at least one of oxygen and ozone.

14. The method for cleaning a contaminant according to claim 13, further comprising a step of moving the stage, while irradiation of UV toward the substrate is blocked, such that irradiation of UV toward the substrate is blocked to enable the contaminant to be positioned in the UV irradiation site.

15. The method for cleaning a contaminant according to claim 13, wherein controlling a UV irradiation shape is performed while irradiation of UV toward the substrate is blocked.

16. The method for cleaning a contaminant according to claim 13, wherein a size of the cross section of UV when controlling a UV irradiation shape is greater than the size of the image recognized by the control means.

17. The method for cleaning a contaminant according to claim 13, wherein in the step of controlling a UV irradiation shape, the UV irradiation shape varies as a shape of a contaminant varies during the cleaning.

18. The method for cleaning a contaminant according to claim 13, wherein a size of the contaminant is between about 1 μm to about 1000 μm.

19. A method for cleaning a residual contaminant on a substrate by using UV comprising:
positioning a substrate on a stage;
obtaining an image of a contaminant existing on a surface of the substrate by using an imaging means;
recognizing the image obtained by the imaging means and generating a control signal in accordance with the recognized image by a control means;
generating UV;
controlling a UV irradiation shape toward the substrate to correspond to a shape of the image recognized in the control means by selectively blocking a passage of the UV in accordance with the control signal;
cleaning the contaminant by irradiating the UV, for which the irradiation shape is controlled, to the contaminant and supplying at least one of oxygen and ozone;
monitoring variation of a shape of the contaminant in real time during cleaning by using the imaging means to obtain a new image;
recognizing the new image and generating a new control signal in accordance with the newly recognized image in the control means; and
controlling the UV irradiation shape again in accordance with the new generated control signal to make the UV irradiation shape generally correspond with the image newly recognized in the control means.
